(19) United States
(12) Patent Application Publication
(10) Pub. No.: US 2014/0067724 A1
(43) Pub. Date: Mar. 6, 2014

(54) AUTOMATED PRICING FILES

(71) Applicants: Peter J. Klausner, Scottsdale, AZ (US); Bobbi J. Richardson, Chandler, AZ (US)

(72) Inventors: Peter J. Klausner, Scottsdale, AZ (US); Bobbi J. Richardson, Chandler, AZ (US)

(21) Appl. No.: 13/601,679

(22) Filed: Aug. 31, 2012

(51) Int. Cl. G06Q 30/02

(52) U.S. Cl. CPC G06Q 30/0283
USPC 705/401

(57) ABSTRACT

Postage pricing data may be determined and reported in a uniform manner from data files. The data files may be provided to a vendor and include postage pricing data, mailing attribute data and other data for locating the appropriate postage. To obtain postage pricing, a number of attributes associated with a user's mailing are identified. A first data file may be searched using the attribute data. A key is accessed from the first data file based on the attributes and then a second data file is searched using the key and a pricing structure. The postage price for the mailing may then be retrieved from the search of the second data file. The postage pricing data may cover domestic mail, international mail, mailing services and discount information, and may be reported to a user via a display or electronic communication

### BACKGROUND OF THE INVENTION

The United States Postal Service (USPS) provides a variety of services for sending packages of various types in a variety of ways. Mailings may each be associated with a variety of parameters, which collectively result in a required postage for each mailing. It has been a challenge for customers wishing to ship a mailing to remotely retrieve exact postage data in a fast, convenient and efficient manner, as well as for mailing vendors to determine postage on a broad scale for the customers.

Previous methods for providing postage information manually include looking up postage in a series of booklets, a call-in line provided by the U.S. Postal Service, online rate calculators, and files such as comma separated value files. Each of these has disadvantages such as being too tedious, has inconsistent availability, is difficult for vendors to implement as part of their own service, or simply being inconvenient. What is needed is an improved way to provide a pricing solution by the Postal Service pricing information to customers to implement in their own environment as well as to vendors.

### SUMMARY OF THE CLAIMED INVENTION

The present technology provides postage pricing data in a uniform manner from data files with postage pricing and a number of attributes and other data for locating the appropriate postage. Postage pricing data may be provided to a vendor as one or more data files. To obtain postage pricing, a number of attributes and a pricing structure associated with a user's mailing are identified, for example from input provided by a user of the mailing. A first data file is searched using the attribute data. A key and a pricing structure is accessed from the first data file based on the attributes and then a second data file is searched using the key, pricing structure and optionally other mailing information. The other mailing information may include weight, and zones for the mailing. The postage price for the mailing may then be retrieved from the search of the second data file. The postage pricing data may cover domestic mail, international mail, mailing services and discount information, and may be reported to a user via a display or remote electronic communication (i.e., email, text, other electronic communication).

An embodiment may include a method for automatically determining postage pricing. A key file stored in memory may be searched for a first record having a set of attribute values that matches a set of mailing attribute values. The first key file record may be one of a plurality of records within the key file stored in memory. A key from the first record may be accessed by a module executed by a processor. A pricing file stored in memory may be searched for a second record having a first key which matches the accessed key. The second pricing file record may be one of a plurality of records within the pricing file stored in memory. Postage pricing data may be accessed from the second pricing file record stored in memory based on the key and additional mailing data. The pricing file may be read based on the pricing structure. The postage pricing data may be reported.

An embodiment including a system for automatically determining postage pricing may include a processor, a memory, a key module, a pricing module, and a management module. The key module may be stored in the memory and executed by the processor to search a key file for a first record having a set of attribute values that matches a set of mailing attribute values. The key module may also be executed to access a key from the first record. The first key file record may be one of a plurality of records within the key file and stored in memory. The pricing module may be stored in memory and executed by the processor to search a pricing file for a second record having a first key which matches the accessed key. The pricing module may also be executed to access postage pricing data from the second pricing file record based on the key and additional mailing data. The pricing file may be read based on the pricing structure. The second pricing file record may be one of a plurality of records within the pricing file. A management module may be stored in the memory and executed by the processor to report the postage pricing information.

### BRIEF DESCRIPTION OF THE DRAWINGS

FIG. 1 is a block diagram of an exemplary system for automatically providing postage pricing data.

FIG. 2 is a block diagram of an exemplary vendor device.

FIG. 3 is an exemplary method for reporting a postage price.

FIG. 4 is an exemplary table of key data and pricing data.

FIG. 5 is another exemplary table of key data and pricing data.

FIG. 6 is another exemplary table of key data and pricing data.

FIG. 7 illustrates an exemplary computing system.

FIG. 8 is a block diagram of an exemplary mobile device.

### DETAILED DESCRIPTION

Postage pricing data may be determined and reported in a uniform manner from data files. The data files may include postage pricing data, mailing attribute data, pricing structure data and other data for locating the appropriate postage. Postage pricing data may be provided to a vendor as one or more data files. To obtain postage pricing, a number of attributes associated with a user's mailing are identified, for example from input provided by a user of the mailing. A first data file may be searched using the attribute data. A key and pricing structure data may be accessed from the first data file based on the attributes and then a second data file is searched using the key, pricing structure data and other mailing information. The other mailing information may include mailing weight and zones for the mailing. The postage price for the mailing may then be retrieved from the search of the second data file. The postage pricing data may cover domestic mail, international mail, mailing services and discount information, and may be reported to a user via a display or remote electronic communication.

The automatic postage pricing system of the present technology has several advantages. First, the entire price determination process is automatic and more convenient compared to previous solutions. The present system supports many classes of mail and allows for multiple price point retrieval per customer (i.e., a customer may retrieve price data for different mailing classes for a mailing). Each set of prices may be pre-loaded as a file with effective start dates and contractual expiration dates. The model is created as a data-driven model which reduces coded business rules. This data model allows vendors and customers to implement the Automated Pricing Files according to their programming standards. Vendors may use the data within their systems rather than comply with USPS network system business rules. The present system also allows vendors to manipulate the data as they need, for example by maintaining smaller portions of tables that are applicable to their customers.

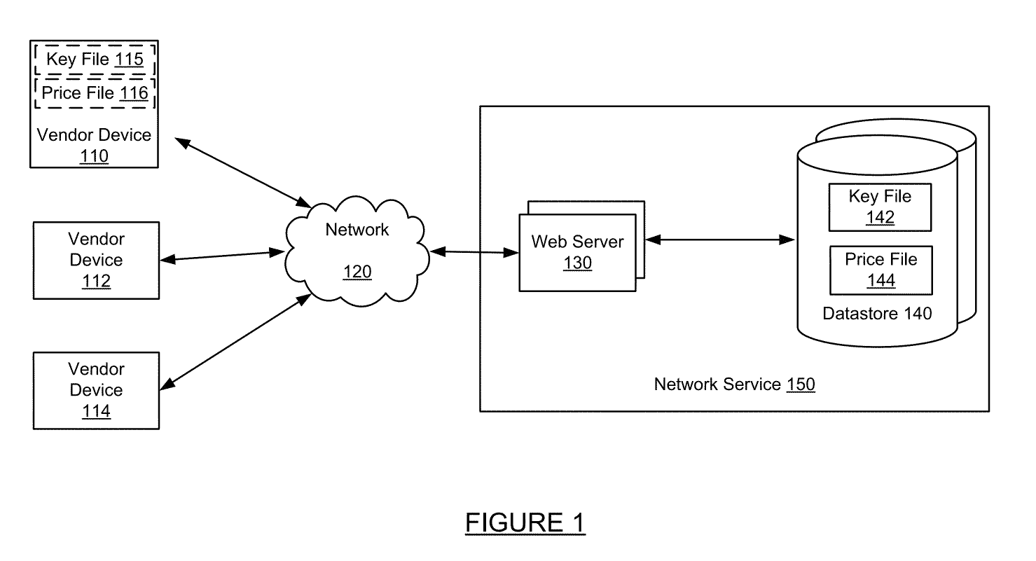

FIG. 1 is a block diagram of an exemplary system for automatically providing postage pricing. The system of FIG. 1 includes vendor devices 110, 112 and 114, network 120, and network service 150. Network service 150 includes web server 130 and database 140 and may be provided by an entity with access to the key file and pricing file, such as the USPS.

Each vendor device or customer device 110-114 may be implemented as one or more computing devices such as a workstation, laptop computer, desktop computer, smart phone, tablet computer, or some other device. A vendor device 110 may receive and store a key file 115 and price file 116 from database 140 via network 120 and web server 130. The locally stored price file and key file may be a mirror copy of the files stored in datastore 140 or portions of the datastore 140 files.

A vendor device 110 may include software, hardware, and other logic to perform queries and search the key file and price file to provide postage pricing for a user. The information requested from the user may include a number of attributes and other information associated with the user's planned mailing. The additional information may include the mailing type, weight, and distance traveled by the mailing.

Though referred to as a vendor device, computing devices 110-114 may be implemented for customers of the postal service rather than vendors that sell to customers. Reference to the devices as a “vendor” device is strictly for purposes of illustration, and is not intended to limit the scope of the present technology of application thereof.

Network 120 may communicate with vendor devices 110-114 and web server 130. Network 120 may include one or more intranets, extranets, a private network, a public network, the Internet, and any combination of these networks.

Web server 130 may be formed by one or more servers which handle requests received over network 120. The requests may be for key files and price files stored in database 140, or information within those files. Web server 130 receives requests, such as for example a request to retrieve the key files and price files associated with a particular date, processes the requests by sending a query to datastore 140, and provides the files to the requesting device, such as vendor device 110.

In some embodiments, web server 130 may also perform queries on files stored in database 140. In this case, rather than retrieving the entire file, web server 130 may receive a request for pricing data based on one or more attributes and other mailing information, or may request a portion of one or more files. Web server 130 may process the request by querying database 140 with attributes received over network 120 from vendor device 110 when requested for just postage pricing data, database 140 may determine a key based on the attributes, retrieve pricing information based on the retrieved key and other mailing data, and report the pricing to web server 130.

Database 140 may be implemented using one or more data stores. Each datastore 140 may include all or a portion of a key file 142 and price file 144. Key file 142 includes a series of keys that each correspond to a set of postage attribute values. Price file 144 includes postage pricing information that corresponds to particular postage keys and other information. The other information may include mailing type, weight, zone and other data.

In some embodiments, the files 142 and 144 may be implemented as one or more files. The data in the files may be in table format, and may be joined as a single table or divided into multiple tables. The files may be provided to a vendor or customer as one or more files or tables.

FIG. 1 is discussed as an example of one of many possible implementations of a system for providing postage information as discussed herein. The system for providing the postage information may be distributed over several devices or machines, implemented at remote network servers (i.e., “in the cloud”), maintained locally on a work station or smart device, a combination of these implementations, and other systems. The system of FIGURE is used merely for exemplary purposes, and is not intended to limit the scope of the present technology.

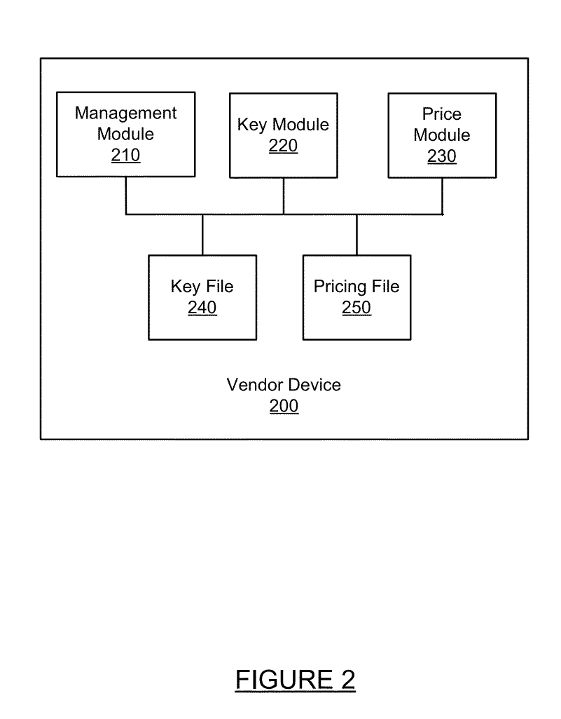

FIG. 2 is a block diagram of an exemplary vendor device. Vendor device 200 of FIG. 2 includes management module 210, key module 220, price module 230, key file 240, and pricing file 250. Modules 210-230 may be implemented by software, such as a method, object, code or other software stored in vendor device memory and executed by one or more vendor device processors to perform functions described herein. Modules 210-230 may communicate with each other and be implemented as a combination of executable software and hardware and logic. Files 240 and 250 may also be stored in memory, may be accessed and processed by modules 210-230, and may include one or more files or sets of data.

Though specific modules are discussed, the scope of the invention is not limited to a system that uses these modules. More or fewer modules may be used, and variations of the modules used are within the scope of the present technology.

Management module 210 may receive postage attribute information and provide the information to key module 220. The attribute information may be received from a user, a remote location or device, or other location.

The attributes may include mail class, mail shape/packaging, mail machinability/preparation, mail sort, and mail entry point. The mail class attribute identifies the class of mailing, and may for example include classes of first class, priority, express, standard, parcel post, parcel select, bound printed matter, standard mail marketing, and other classes. The mail shape/packaging may indicate the type or shape of the mailing to be sent by a user. Examples of mail shape/packaging include letter, card, flat, parcel, large flat rate box, regional box, cubic, and other mail shapes and packaging. Mail machinability/preparation identifies types of machineability or preparation done to a mailing before it is dropped off with the Postal Office. Examples of machinability and/or preparation include automation, non-automation, machinable, irregular, presorted, carrier route, and none. The sort attribute identifies the level of sort done and sort information provided. Examples of sort include carrier route saturation (CRSAT), carrier route high density (CRHD), carrier route basic (CRBAS), basic, five-digit, three-digit, AADC, ADC, NDC, single piece, and presorted. Mail entry may indicate the entry of the mailing by the user. Examples of mail entry include DNDC, DSCF, DDU, and ONDC.

In addition to receiving postage attributes from a user or other source, management module 210 may report a postage price for the particular mailing. The postage price is provided from one or more other modules within vendor device 200 to management module 210, which then reports the information to a user. The reporting may be provided via a display, electronic message, or other means.

Key module 220 may search key file 240 at vendor device 110 using the attributes received by management module 210. Key module 220 accesses a key and pricing structure based on the attributes and stores the key in vendor device memory.

Price module 230 retrieves postage pricing from a pricing file using the key, pricing structure and other mailing data. Price module 230 obtains and stores the postage price and provides the postage price to management module 210.

The pricing structure types may include ounce based non-zone pricing, pound based non-zone pricing, pound based zone pricing, cubic pricing, flat rate pricing, piece and pound pricing, piece and pound zone pricing, and zone only pricing. Ounce based, non-zone pricing (OZNZ) supports pricing tables with ounce based price breaks with a single price for each break, such as for example Single Piece First Class Mail. Pound based non-zone pricing (LBNZ) supports pricing tables with pound based price breaks with a single price for each break, such as for example, Media Mail. Pound based zone pricing (LBZ) supports pricing tables with pound based price breaks and a price determined by zone, such as for example Priority Mail. Cubic pricing (CU) supports cubic pricing tables with size based price breaks and a price determined by zone, such as for example Priority Mail Cubic Pricing. Flat Rate pricing (FR) supports flat rate pricing, such as for example Priority Mail Flat Rate Box. Piece and Pound pricing (PLB) supports pricing tables where pricing is determined by a combination of a price per piece plus a price per pound, such as for example, Standard Mail. Piece and Pound zone pricing (PLBZ) supports pricing tables where pricing is determined by a combination of a price per piece plus a price per pound priced by zone, such as for example Bound Printed Matter. Zone Only (Z) pricing supports pricing tables where pricing is determined by zone without weight or size breaks, such as for example Regional Rate Boxes. The pricing structure tells the system/module how to interpret the data in the key file which includes the postage prices.

The other mailing data retrieved by price module 230 may include package zones which the mailing will cover, weight of the mailing, and other data.

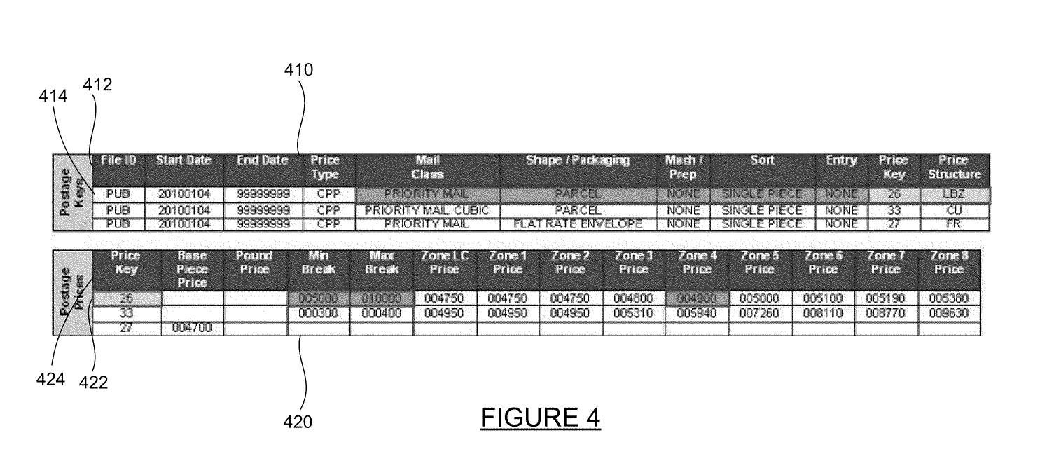

Key file 240 may be retrieved from database 140 and stored locally at vendor device 200. Pricing file 250 may be retrieved from the postal network service 150. Examples of tables including key file data and pricing file data are discussed below with respect to FIGS. 4-6.

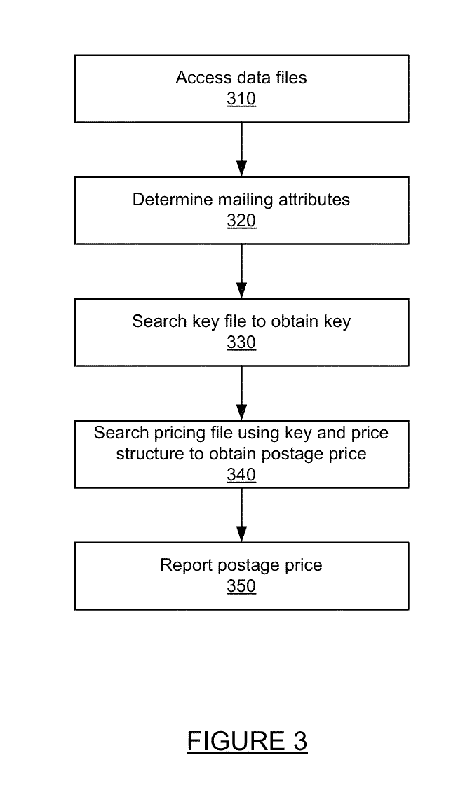

FIG. 3 is an exemplary method for reporting a postage price. The method of FIG. 3 may be performed by one or more modules of vendor device 200. Data files may be accessed at step 310. A vendor device (i.e., devices 110-114) may access data files from network service 150. The data files may include a key file and a price file. The vendor device may request the entire file or portions of the files for certain dates, mail classes, or multiple dates and mail classes.

Mailing attributes are determined at step 320. Mailing attributes may be received from a user through an interface provided by a management module. Mailing attributes may also be received over a network. The attributes may include values for the mail class, shape/packaging, machinability/preparation, sort and entry. The attributes are received and may be stored locally at a vendor device.

A key file may be searched at step 330. The key file data may be searched by a key module based on the attributes determined at step 320. An access key corresponding to a number of specified attributes, such as five attributes, may then be obtained by key module 220 from the key file 240. A pricing structure may also be retrieved form the key file. A pricing file may be searched using the key and the price structure to obtain a postage price at step 340. Other mailing data may also be used to determine the postage price, such as the zone of the mailing and weight of the mailing. The postage pricing retrieved from the pricing file is reported at step 350. The postage price may be reported as a price for a particular mailing, a mailing based on a variety of classes, and other formats. The reporting may be in the form of a display in a computer or mobile device, an electronic mail message, a text message, or other communication.

FIG. 4 is an exemplary table of key file data and a table of pricing file data. The columns of key data table 410 correspond to a file identifier, start date, end date, price type, mail class, mail shape/packaging, mail machinability/preparation, mail sort, mail entry, price key, and price structure. The column values of the key table 410 includes a file identification of publication, a start date of Jan. 4, 2010, no end date, and a price type of CPP.

The next five columns correspond to five attributes which may be used to determine the key. The five attribute values include a mail class of priority mail, mail shape/packaging of parcel, no mail machinability/preparation, mail sort of single piece, and no specified mail entry. The corresponding price key found in row one is price key 26. The price structure is listed as pound-zone, and may be used to determine the price along with the key from pricing file data.

In FIG. 4, the first column of data in table 410 uses a weight based price structure to determine the postage price. The postage key and price file data support multiple pricing structures which support multiple prices in the United States Postal Service operation.

The pricing structures include ounce-based nonzone pricing, pound-based nonzone pricing, pound-based zone pricing, cubic pricing, flat rate pricing, piece and pound pricing, piece and pound zone pricing and zone only. Ounce-based nonzone pricing supports pricing tables with ounce-based price breaks with a single price for each break, such as single piece first class mail. Pound-based nonzone pricing supports pricing tables with pound-based price breaks with a single price for each break, such as media mail. Pound-based zone pricing supports pricing tables with pound-based price breaks and a price determined by zone, such as priority mail. Cubic pricing supports pricing tables with size-based price breaks and a price determined by zone, such as for example, priority mail cubic pricing. Flat rate pricing is a flat rate regardless of zone. Piece and pound pricing supports pricing tables where pricing is determined by a combination of a price per piece plus a price per pound, such as standard mail. Piece and pound zone pricing supports pricing tables where pricing is determined by a combination of price per piece plus a price per pound price by zone, such as bound printed matter. Zone only supports pricing tables where pricing is determined by zone without weight or size breaks, such as for example regional rate boxes.

Though particular price structures are discussed herein, other types of structures may be used with the present technology. In fact, the data structure is designed such that new price structure types may be added dynamically for use in determining postage pricing.

Table 420 of FIG. 4 includes pricing file data which corresponds to particular keys. For example, the first row of data in pricing data table 420 corresponds to price key 26. The columns of the pricing table are labeled price key, base piece price, pound price, minimum break, maximum break, zone LC price, zone one price, zone two price, zone three price, zone four price, zone five price, zone six price, zone seven price and zone eight price. The illustrated columns are for illustrative purposes and the actual files may include addition data elements to support additional classes of mail.

As illustrated in the pricing table 420, price key 26 corresponds to a series of different prices based on the zone where the mailing is traveling as well as weight boundaries. For example, the weight of the mailing for key 26 will be between five ounces and ten ounces, and corresponding prices are given for multiple zones. In this case, the mailing will be traveling over four postal zones and corresponds to a price of $4.90.

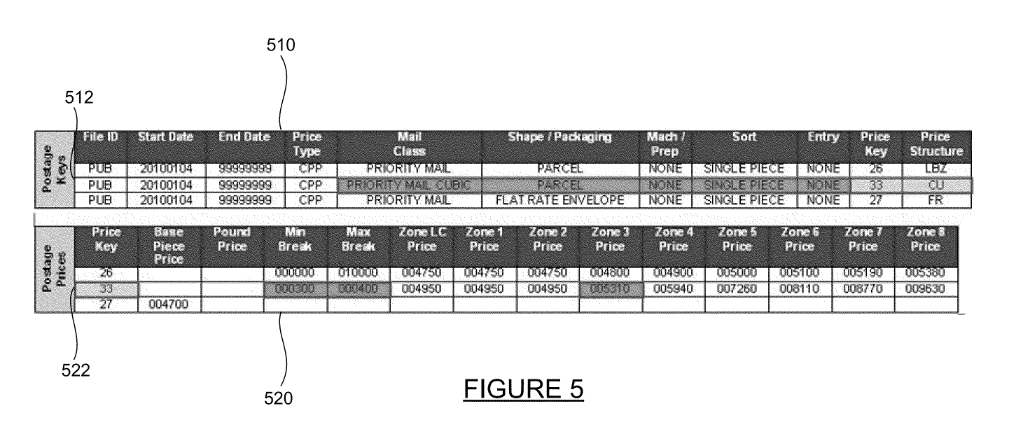

FIG. 5 illustrates another exemplary table of key data and pricing data. In FIG. 5, the first column of data in table 510 uses a volume based price structure to determine the postage price In table 510, the second row 512 indicates a mail class of priority mail cubic, mail shape/packaging of parcel, no mail machinability/preparation, mail sort of single piece, and no mail entry. The corresponding price key is 33.

In pricing table 520 of FIG. 5, price key 33 corresponds to a price for different zones, with a minimum break value of 300 and maximum break value of 400. In this case, the break values correspond to cubic feet, so the pricing in the row corresponding to price key 33 corresponds to a package size that is at least 0.3 cubic feet and no greater than 0.4 cubic feet. When the package will travel across three postal zones, the corresponding price is $53.10.

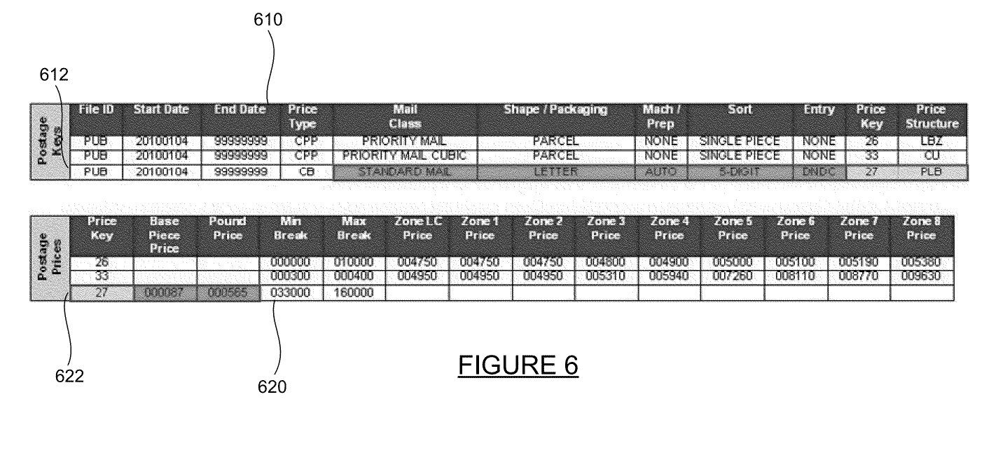

FIG. 6 illustrates another exemplary table of key file data and pricing file data. In FIG. 6, the first column of data in table 610 uses a flat rate based price structure to determine the postage price. Key data table 610 includes a third row with field data of a start date of Jan. 4, 2010, no end date, a CB (commerical base) price type, a class of standard mail, mail shape/packaging of letter, machinability/preparation of automation, a mail sort of 5-digit and mail entry of DNDC. These attribute values correspond to a price key value of 27. In the pricing table 620, price key 27 corresponds to a base piece price of $0.087 per piece and $0.565 per pound. As illustrated, the zone fields are all blank because they are not relevant when there is a flat rate.

The tables illustrated in FIGS. 4-7 are provided for purposes of discussion, and the are not intended to be limiting. The key data and pricing data may include additional fields, and may be stored in formats other than a table.

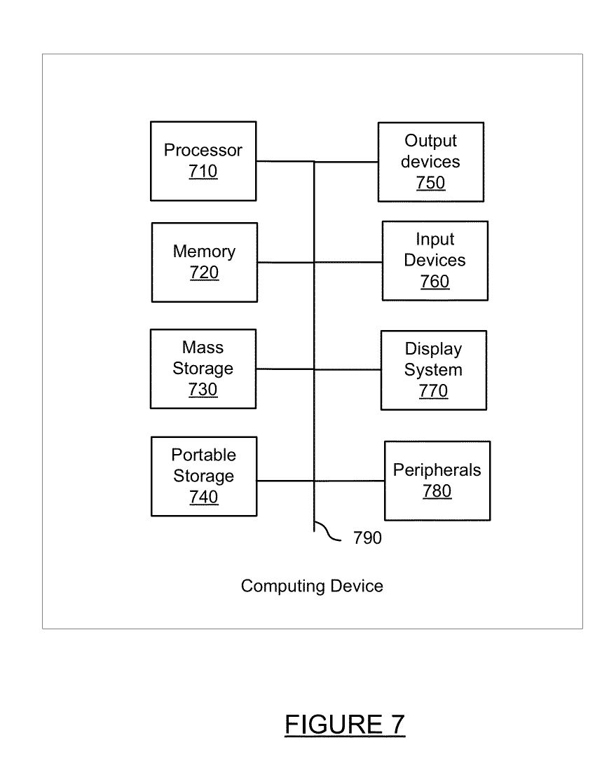

FIG. 7 illustrates an exemplary computing system 700 that may be used to implement a computing device for use with the present technology. System 700 of FIG. 7 may be implemented in the contexts of the likes of web server 130, datastore 140, and one or more of vendor devices 110-114. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

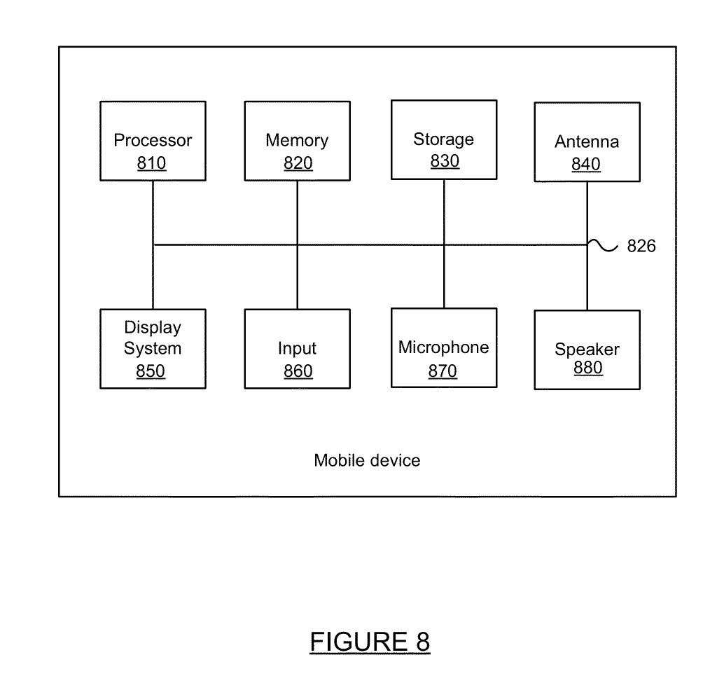

FIG. 8 illustrates an exemplary mobile device system 800 that may be used to implement a mobile device for use with the present technology, such as for example in the contexts of the likes of one or more of vendor devices 110-114. The mobile device 800 of FIG. 8 includes one or more processors 810 and memory 860. Memory 860 stores, in part, programs, instructions and data for execution and processing by processor 810. The system 800 of FIG. 8 further includes storage 830, one or more antennas 840, a display system 850, inputs 860, one or more microphones 870, and one or more speakers 880.

The components shown in FIG. 8 are depicted as being connected via a single bus 890. However, the components 810-880 may be connected through one or more data transport means. For example, processor unit 810 and main memory 860 may be connected via a local microprocessor bus, and storage 830, display system 850, input 860, and microphone 870 and speaker 880 may be connected via one or more input/output (I/O) buses.

Memory 860 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 860 can store the system software for implementing embodiments of the present invention for purposes of loading that software into main memory 810.

Antenna 840 may include one or more antennas for communicating wirelessly with another device. Antenna 840 may be used, for example, to communicate wirelessly via Wi-Fi, Bluetooth, with a cellular network, or with other wireless protocols and systems. The one or more antennas may be controlled by a processor 810, which may include a controller, to transmit and receive wireless signals. For example, processor 810 execute programs stored in memory 860 to control antenna 840 transmit a wireless signal to a cellular network and receive a wireless signal from a cellular network.

Display system 850 may include a liquid crystal display (LCD), a touch screen display, or other suitable display device. Display system 870 may be controlled to display textual and graphical information and output to text and graphics through a display device. When implemented with a touch screen display, the display system may receive input and transmit the input to processor 810 and memory 860.

Input devices 860 provide a portion of a user interface. Input devices 860 may include an alpha-numeric keypad, such as a keyboard, for inputting alpha-numeric and other information, buttons or switches, a trackball, stylus, or cursor direction keys.

Microphone 870 may include one or more microphone devices which transmit captured acoustic signals to processor 810 and memory 860. The acoustic signals may be processed to transmit over a network via antenna 840.

Speaker 880 may provide an audio output for mobile device 800. For example, a signal received at antenna 840 may be processed by a program stored in memory 860 and executed by processor 810. The output of the executed program may be provided to speaker 880 which provides audio. Additionally, processor 810 may generate an audio signal, for example an audible alert, and output the audible alert through speaker 880.

The mobile device system 800 as shown in FIG. 8 may include devices and components in addition to those illustrated in FIG. 8. For example, mobile device system 800 may include an additional network interface such as a universal serial bus (USB) port.

The components contained in the computer system 800 of FIG. 8 are those typically found in mobile device systems that may be suitable for use with embodiments of the present invention and are intended to represent a broad category of such mobile device components that are well known in the art. Thus, the computer system 800 of FIG. 8 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically determining postage pricing, comprising:
searching a key file stored in memory for a first record having a set of attribute values that matches a set of mailing attribute values, the first key file record one of a plurality of records within the key file stored in the memory;
accessing a key from the first record by a module executed by a processor;
searching a pricing file stored in memory for a second record having price structure and a first key which matches the accessed key, the second pricing file record one of a plurality of records within the pricing file stored in memory; and
accessing postage pricing data from the second pricing file record stored in memory based on the key, a pricing structure and additional mailing data.

2. The method of claim 1, wherein the attributes include mail class, mail shape/packaging, machinability, sort and entry point.

3. The method of claim 1, wherein the additional mailing data includes zone data.

4. The method of claim 1, wherein the additional mailing data includes weight data and volume data.

5. The method of claim 1, wherein the first record includes a price structure type used to read the pricing data table.

6. The method of claim 1, further comprising accessing the key file having a plurality of records and a pricing file having a plurality of records.

7. The method of claim 6, wherein the key file and pricing file are received from a remote server.

8. The method of claim 1, wherein the key file includes a start date at which a postage price corresponding to the keys are valid.

9. The method of claim 1, wherein the key file includes an end date before which a postage price corresponding to the keys are valid.

10. The method of claim 1, wherein the postage pricing data corresponds to postage for a mailing having a destination within the United States.

11. The method of claim 1, wherein the postage pricing data corresponds to postage for a mailing having a destination outside the United States.

12. The method of claim 1, further comprising reporting the postage pricing data.

13. A computer readable non-transitory storage medium having embodied thereon a program, the program being executable by a processor to perform a method for automatically determining postage pricing, the method comprising:
searching a key file for a first record having a set of attribute values that matches a set of mailing attribute values, the first key file record one of a plurality of records within the key file;
accessing a key from the first record;
searching a pricing file for a second record having a first key which matches the accessed key, the second pricing file record one of a plurality of records within the pricing file; and
accessing postage pricing data from the second pricing file record based on the key, the price structure and additional mailing data.

14. The computer readable non-transitory storage medium of claim 13, wherein the attributes include mail class, mail shape/packaging, machinability, sort and entry point.

15. The computer readable non-transitory storage medium of claim 13, wherein the additional mailing data includes zone data.

16. The computer readable non-transitory storage medium of claim 13, wherein the additional mailing data includes weight data or volume data.

17. The computer readable non-transitory storage medium of claim 13, wherein the first record includes a price structure type, the additional mailing data including a price structure value.

18. The computer readable non-transitory storage medium of claim 13, the method further comprising accessing the key file having a plurality of records and a pricing file having a plurality of records.

19. The computer readable non-transitory storage medium of claim 18, wherein the key file and pricing file are received from a remote server.

20. The computer readable non-transitory storage medium of claim 13, wherein the key file includes a start date at which a postage price corresponding to the keys are valid.

21. The computer readable non-transitory storage medium of claim 13, wherein the key file includes an end date before which a postage price corresponding to the keys are valid.

22. The computer readable non-transitory storage medium of claim 13, wherein the postage pricing data corresponds to postage for a mailing having a destination within the United States.

23. The computer readable non-transitory storage medium of claim 13, wherein the postage pricing data corresponds to postage for a mailing having a destination outside the United States.

24. The computer readable non-transitory storage medium of claim 13, the method further comprising reporting the postage pricing data.

25. A system for automatically determining postage pricing, comprising:
a processor;
a memory;
one or more modules stored in the memory and executed by the processor, execution of the one or more modules by the processor:
searching a key file for a first record having a set of attribute values that matches a set of mailing attribute values and access a key and price structure from the first record, the first key file record one of a plurality of records within the key file and stored in memory;
searching a pricing file for a second record having a first key which matches the accessed key and accessing postage pricing data from the second pricing file record based on the key, a pricing structure and additional mailing data, the second pricing file record one of a plurality of records within the pricing file; and
reporting the postage pricing information.
